(19) United States
(12) Patent Application Publication
(10) Pub. No.: US 2017/0153626 A1
(43) Pub. Date: Jun. 1, 2017

(54) CAM DATA DISPLAY DEVICE

(71) Applicant: FANUC CORPORATION, Minamitsuru-gun (JP)

(72) Inventor: Yuuki Oonishi, Minamitsuru-gun (JP)

(73) Assignee: FANUC CORPORATION, Minamitsuru-gun (JP)

(21) Appl. No.: 15/363,194

(22) Filed: Nov. 29, 2016

(30) Foreign Application Priority Data
Nov. 30, 2015 (JP) 2015-232757

(51) Int. Cl. G05B 19/4069; G05B 19/414; G06T 11/20

(52) U.S. Cl. CPC G05B 19/4069; G06T 11/206; G05B 19/414; G05B 2219/43174; G05B 2219/49361

(57) ABSTRACT

A cam data display device is designed to perform waveform display of a motion of an electronic cam and is provided with a cam-shape data storage unit configured to store cam-shape data in which a phase of a camshaft is associated with a position of a slave axis, a camshaft rotational speed acquisition unit configured to acquire a rotational speed of the camshaft, and a waveform generation unit configured to generate the waveform display indicative of the relationship between time and the motion of the slave axis, based on the cam-shape data and the rotational speed of the camshaft.

### BACKGROUND OF THE INVENTION

Field of the Invention

The present invention relates to a cam data display device, and more particularly, to a cam-shape data display method based on the consideration of the rotational speed of a camshaft.

Description of the Related Art

There have conventionally been used electronic cams that electrically implement the same motion as that of mechanical cams. In an electronic cam, the motion of a mechanical cam of a certain shape can be electrically reproduced by defining the position of a slave axis synchronously with the phase of a camshaft axis (master axis). Data that defines the correspondence between the phase of the camshaft and the position of the slave axis is called cam-shape data (FIG. 4). In general, the cam-shape data is created or confirmed by means of a cam data display device.

For example, Japanese Patent Application Laid-Open No. 2004-114176 describes a configuration in which the correspondence between a camshaft phase (angle) and a slave axis position is defined as a data table. This configuration is advantageous in that a synchronous motion of an electronic cam can easily be created.

According to the data table disclosed in Japanese Patent Application Laid-Open No. 2004-114176, it is difficult to understand the motion of the electronic cam at a glance. Therefore, in order to easily understand the motion of the electronic cam, in a cam data display device, waveform display is performed in such a manner that cam-shape data is displayed in a graph with two axes that represent the camshaft phase and the slave axis position, individually (FIG. 5).

However, if a machine is equipped with a speed reduction mechanism such as a crank so that the rotational speed of the camshaft changes in accordance with the phase, for example, it is difficult to understand the behavior of the slave axis by the waveform display with the two axes representing the camshaft phase and the slave axis position (FIG. 6).

More specifically, the rotational speed of the camshaft in each phase cannot be ascertained by the waveform display of conventional cam-shape data such as those shown in FIGS. 5 and 6. Moreover, the change of the slave axis position with time, the maximum values of the operating speed and acceleration of the slave axis, the phase for the maximum values and the like cannot be ascertained. Thus, there is a problem that the appropriateness of the speed and acceleration of the slave axis cannot easily be determined, so that it is difficult to predict the influences of the speed and acceleration if the cam-shape data is modified.

### SUMMARY OF THE INVENTION

The present invention has been made to solve the above problems, and its object is to provide a cam data display device capable of displaying cam-shape data in consideration of the rotational speed of a camshaft.

A cam data display device according to one embodiment of the present invention is a cam data display device which performs waveform display of a motion of an electronic cam and comprises a cam-shape data storage unit configured to store cam-shape data in which a phase of a camshaft is associated with a position of a slave axis, a camshaft rotational speed acquisition unit configured to acquire a rotational speed of the camshaft, and a waveform generation unit configured to generate the waveform display indicative of the relationship between time and the motion of the slave axis, based on the cam-shape data and the rotational speed of the camshaft.

In a cam data display device according to another embodiment, the rotational speed of the camshaft changes in accordance with the phase.

In a cam data display device according to another embodiment, the waveform generation unit generates the waveform display indicative of the relationship between time and the position of the slave axis.

In a cam data display device according to another embodiment, the waveform generation unit generates the waveform display indicative of the relationship between time and a speed of the slave axis.

In a cam data display device according to another embodiment, the waveform generation unit generates the waveform display indicative of the relationship between time and an acceleration of the slave axis.

In a cam data display device according to another embodiment, the waveform generation unit generates the waveform display indicative of the relationship between time and a jerk of the slave axis.

In a cam data display device according to another embodiment, the rotational speed acquisition unit acquires a measured value or a scheduled operating speed.

In a cam data display device according to another embodiment, the rotational speed acquisition unit further acquires rotation direction information on the camshaft.

In a cam data display device according to another embodiment, the waveform generation unit determines the rotation direction based on the rotation direction information and generates the waveform display with an axis indicative of the time inverted if the rotation direction is reversed.

In a cam data display device according to another embodiment, the waveform generation unit determines the rotation direction based on the rotation direction information and generates the waveform display with an axis, indicative of the time after the point in time when the rotation direction is reversed, inverted if the rotation direction is reversed in the middle of rotation.

In a cam data display device according to another embodiment, the waveform generation unit determines the rotation direction based on the rotation direction information and generates the waveform display in varied display forms depending on the rotation direction.

In a cam data display device according to another embodiment, the rotational speed acquisition unit further acquires a rotation start phase of the camshaft, and the waveform generation unit generates the waveform display with the rotation start phase set to a zero time.

According to the present invention, there can be provided a cam data display device capable of displaying cam-shape data in consideration of the rotational speed of a camshaft.

### BRIEF DESCRIPTION OF THE DRAWINGS

The above and other objects and features of the present invention will be obvious from the ensuing description of embodiments with reference to the accompanying drawings, in which:

FIG. 1 is a diagram illustrating processing performed by a cam data display device 100 according to an embodiment of the present invention;

FIG. 2 is a diagram illustrating processing performed by the cam data display device 100 according to the embodiment of the present invention;

FIG. 3 is a diagram showing an example of waveform display generated by the cam data display device 100 according to the embodiment of the present invention;

FIG. 4 is a diagram showing an example of conventional cam-shape data;

FIG. 5 is a diagram showing an example of waveform display of the conventional cam-shape data;

FIG. 6 is a diagram illustrating a problem of the waveform display of the conventional cam-shape data;

FIG. 7 is a diagram showing a configuration of the cam data display device 100 according to the embodiment of the present invention;

FIG. 8A is a diagram showing cam-shape data, among other diagrams showing Example (1) of waveform display generated depending on the structure of a camshaft by the cam data display device 100 according to the embodiment of the present invention;

FIG. 8B is a diagram showing a waveform generated in accordance with the cam shape shown in FIG. 8A, among the other diagrams showing Example (1) of waveform display generated depending on the structure of the camshaft by the cam data display device 100 according to the embodiment of the present invention;

FIG. 8C is a diagram showing an inverted version of the waveform of FIG. 8B, among the other diagrams showing Example (1) of waveform display generated depending on the structure of the camshaft by the cam data display device 100 according to the embodiment of the present invention;

FIG. 9A is a diagram showing Example (2) of waveform display generated depending on the structure of a camshaft by the cam data display device 100 according to the embodiment of the present invention;

FIG. 9B is a diagram showing a waveform created based on the abscissa as a time axis in accordance with the cam shape shown in FIG. 9A, among other diagrams showing Example (2) of waveform display generated depending on the structure of the camshaft by the cam data display device 100 according to the embodiment of the present invention;

FIG. 9C is a diagram showing an inverted version of the waveform of FIG. 9B, among the other diagrams showing Example (2) of waveform display generated depending on the structure of the camshaft by the cam data display device 100 according to the embodiment of the present invention;

FIG. 10A is a diagram showing Example (3) of waveform display generated depending on the structure of a camshaft by the cam data display device 100 according to the embodiment of the present invention;

FIG. 10B is a diagram showing a waveform generated in accordance with the cam shape shown in FIG. 10A, among the other diagrams showing Example (3) of waveform display generated depending on the structure of the camshaft by the cam data display device 100 according to the embodiment of the present invention; and

FIG. 10C is a diagram generated starting at 130° in the waveform of FIG. 10B, among the other diagrams showing Example (3) of waveform display generated depending on the structure of the camshaft by the cam data display device 100 according to the embodiment of the present invention.

### DETAILED DESCRIPTION OF THE PREFERRED EMBODIMENTS

An embodiment of the present invention will now be described with reference to the accompanying drawings.

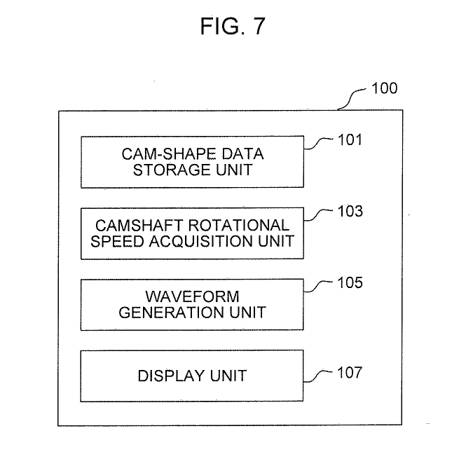

FIG. 7 is a block diagram showing a configuration of a cam data display device 100 according to the embodiment of the present invention. The cam data display device 100 comprises a cam-shape data storage unit 101, camshaft, rotational speed acquisition unit 103, waveform generation unit 105, and display unit 107.

The cam data display device 100 is typically an information processing device such as a personal computer (PC). The cam data display device 100 logically implements various processing units as a CPU performs predetermined processing according to a program stored in a storage area.

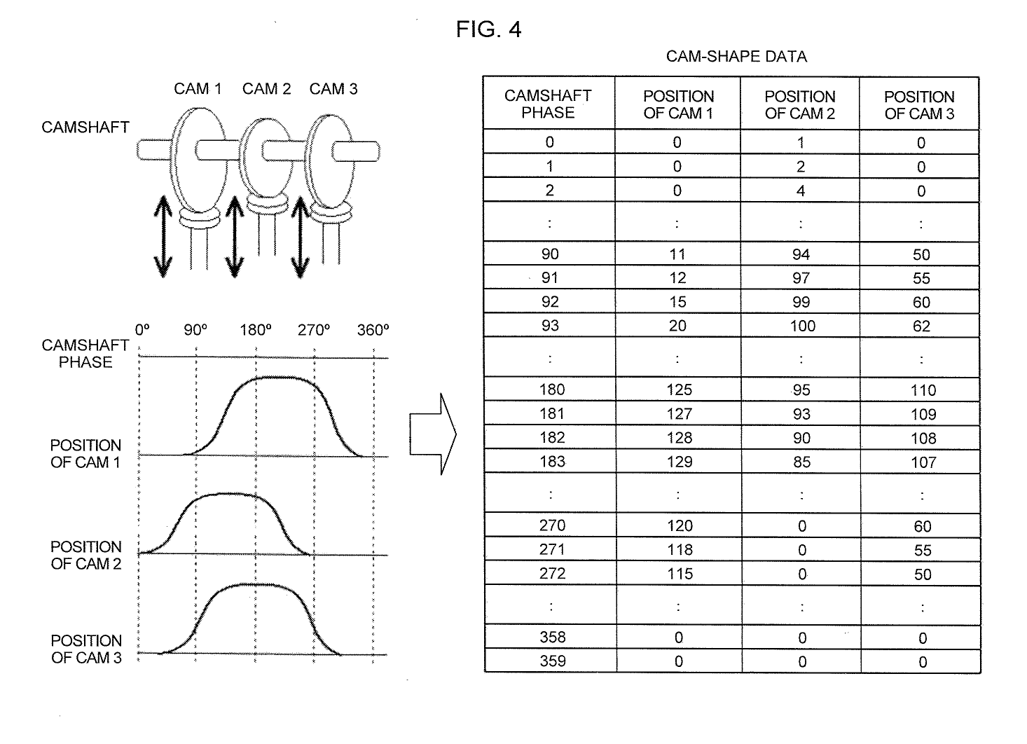

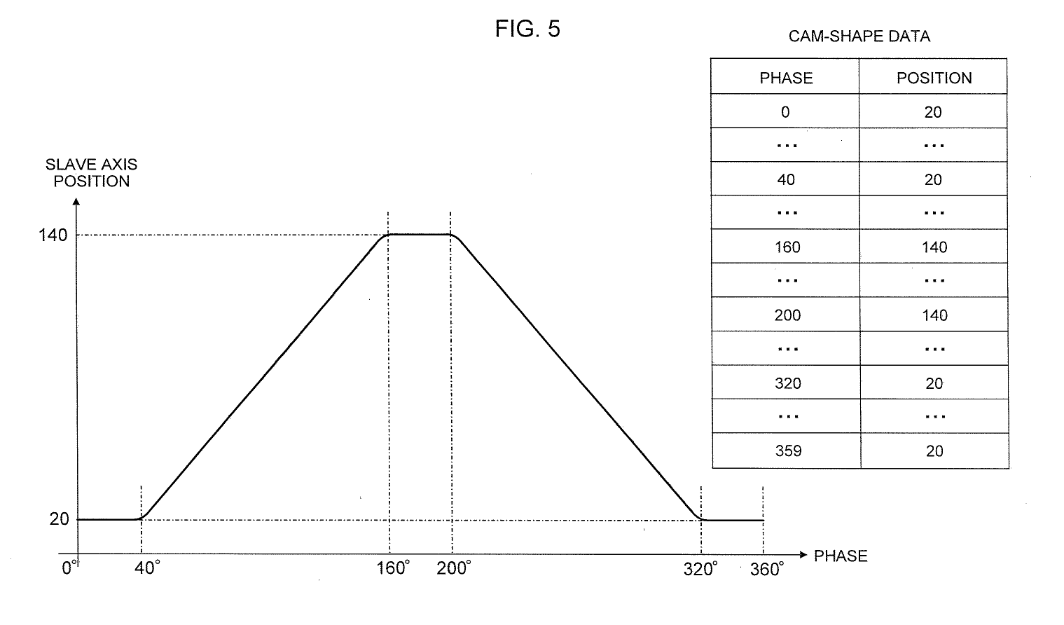

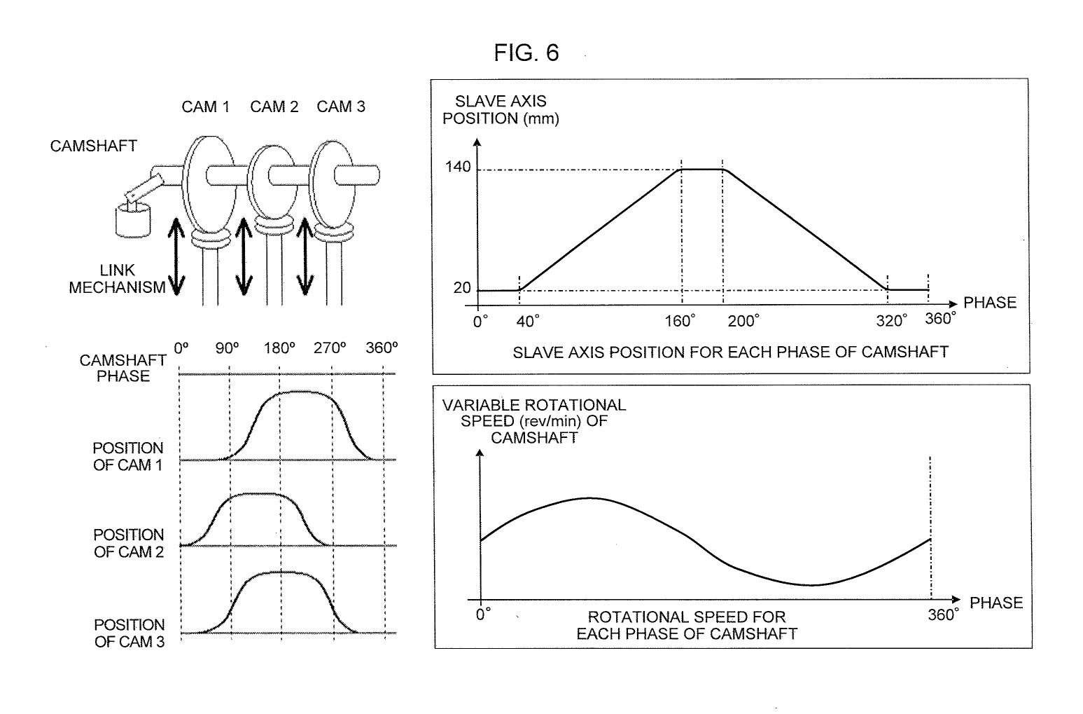

The cam-shape data storage unit 101 stores cam-shape data in which the phase of a camshaft is associated with the position of a slave axis. Typically, the cam-shape data is defined in the form of a table, as shown in FIG. 4 or 5.

The camshaft rotational speed acquisition unit 103 acquires the rotational speed of the camshaft in each phase from data for operation or measured data for the camshaft. The rotational speed is acquired for each 1° in phases ranging from 0° to 359°, for example.

Moreover, the camshaft rotational speed acquisition unit 103 calculates execution times between the phases. For example, it goes on calculating the elapsed time until the transition of the camshaft to the next phase for each 1° in the phases ranging from 0° to 3596°, for example. Then, the camshaft rotational speed acquisition unit 103 stores the rotational speed and execution time in each phase in association with each other.

The waveform generation unit 105 performs processing for generating various waveforms indicative of the motion of the slave axis based on the cam-shape data stored in the cam-shape data storage unit 101. These waveforms are characterized by being generated along the axis of time.

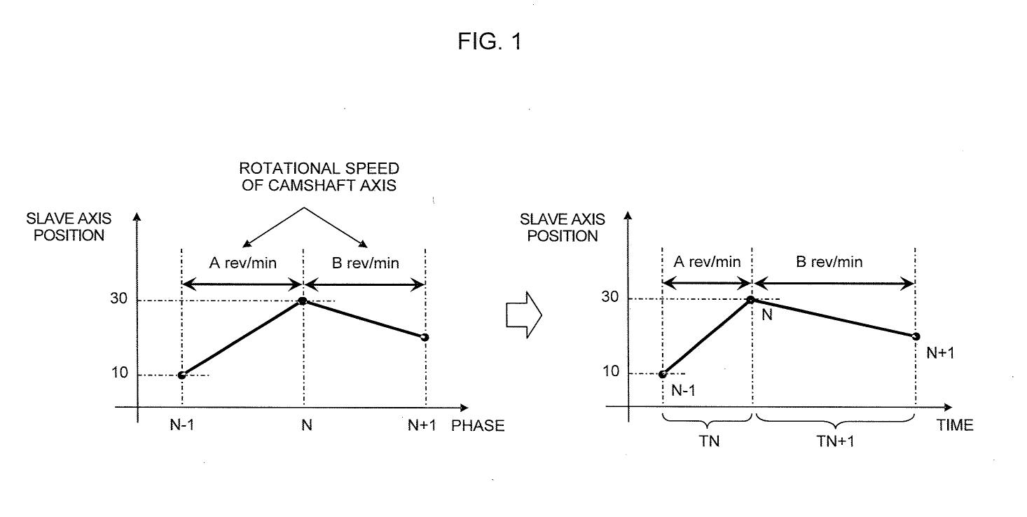

In a conventional method, as shown on the left-hand side of FIG. 1, the cam-shape data is displayed as a waveform with the phase of the camshaft as the abscissa. However, the speed and acceleration, as well as the execution times between the phases (N−1to N and N to N+1), cannot be read from this waveform. As shown on the right-hand side of FIG. 1, in contrast, the waveform generation unit 105 displays the cam-shape data as a waveform with time and the slave axis position as the abscissa and the ordinate, respectively. In this way, execution times (T_{N}, T_{N+1}) between the phases (N−1to N and N to N+1), for example, can be read.

This waveform generation processing will be described more specifically. The waveform generation unit 105 acquires a camshaft rotational speed A (rev/min) in the phase N−1 and a camshaft rotational speed B (rev/min) in the phase N from the camshaft rotational speed acquisition unit 103. Thereupon, the waveform generation unit 105 can calculate the execution time T_{N} from the phase N−1to the phase N and the execution time N+1 from the phase N to the phase N+1 by equations (1) and (2), respectively, as follows:

T_{N}=1/(A÷60×360), (1)

T_{N+1}=1/(B÷60×360). (2)

Moreover, the waveform generation unit 105 individually acquires slave axis positions in the phases N−1, N and N+1 from the cam-shape data storage unit 101. Furthermore, the waveform generation unit 105 individually plots values in the phases N−1, N and N+1 on a coordinate plane in which the abscissa and the ordinate represent time and the slave axis position, respectively. In this way, the waveform shown on the right-hand side of FIG. 1 can be generated.

The display unit 107 performs processing for displaying the waveform generated by the waveform generation unit 105 on a display device or the like.

As an example of execution of the cam data display device 100 of the present invention, a technique for waveform display of cam-shape data is given for the case in which a camshaft is rotated at varied rotational speeds; at 60 rev/min in the phases from 0° to 180° and at 20 rev/min in the phases from 180° to 360°.

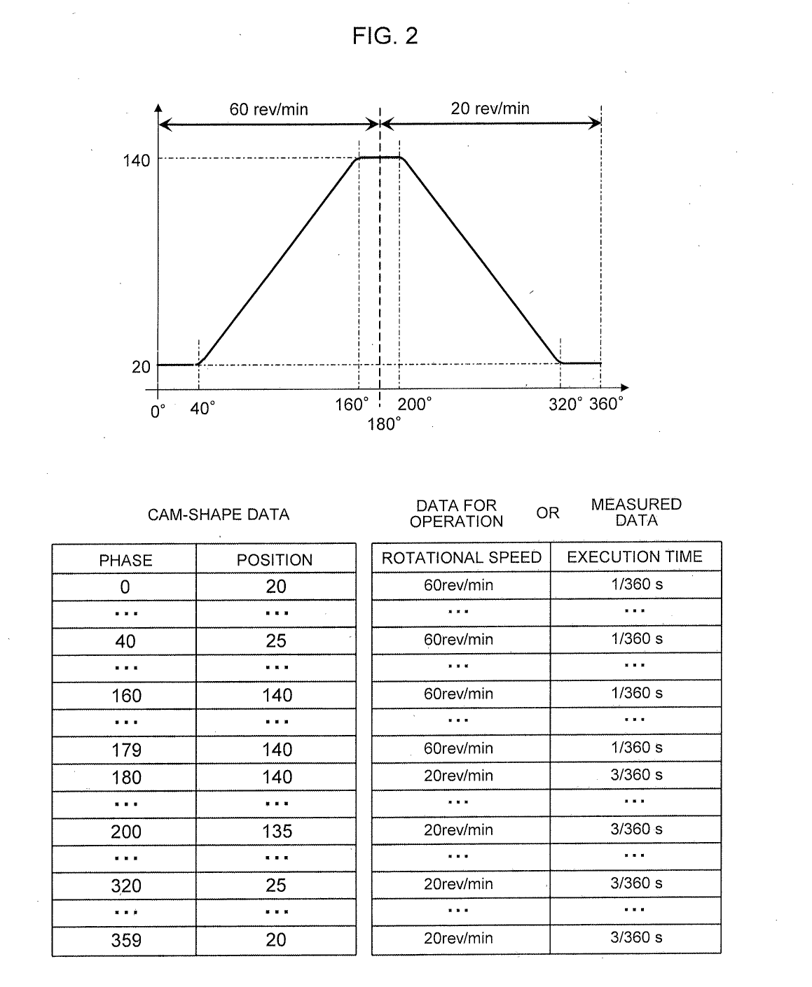

The cam-shape data storage unit 101 is assumed to be stored with cam-shape data such as those shown in FIG. 2. The graph on the left-hand side of FIG. 2 shows an example of the waveform display of the cam-shape data by the conventional technique. Since the abscissa represents the phase of the camshaft in this conventional example, the change in the motion of the slave axis with the passage of time cannot be ascertained.

The camshaft rotational speed acquisition unit 103 acquires the rotational speeds in the phases shown in FIG. 2, based on the data for operation or measured data for the camshaft. In this example, the rotational speeds are 60 rev/min and 20 rev/min in the phases from 0° to 180° and in the phases from 180° to 360°, respectively. Based on this, the camshaft rotational speed acquisition unit 103 calculates the execution time per 1° in the phases from 0° to 180° and that in the phases from 180° to 360° as 1/360 sec and 3/360 sec, respectively, according to the above-described equations (1) and (2). The camshaft rotational speed acquisition unit 103 correspondingly stores the rotational speeds and the execution times in the form of a table, as shown in FIG. 2.

Based on the execution times, the waveform generation unit 105 generates a waveform by transforming the abscissa of the conventional graph shown in FIG. 2 to a time axis. Thereupon, the display unit 107 displays the waveform generated by the waveform generation unit 105 on a display device or the like.

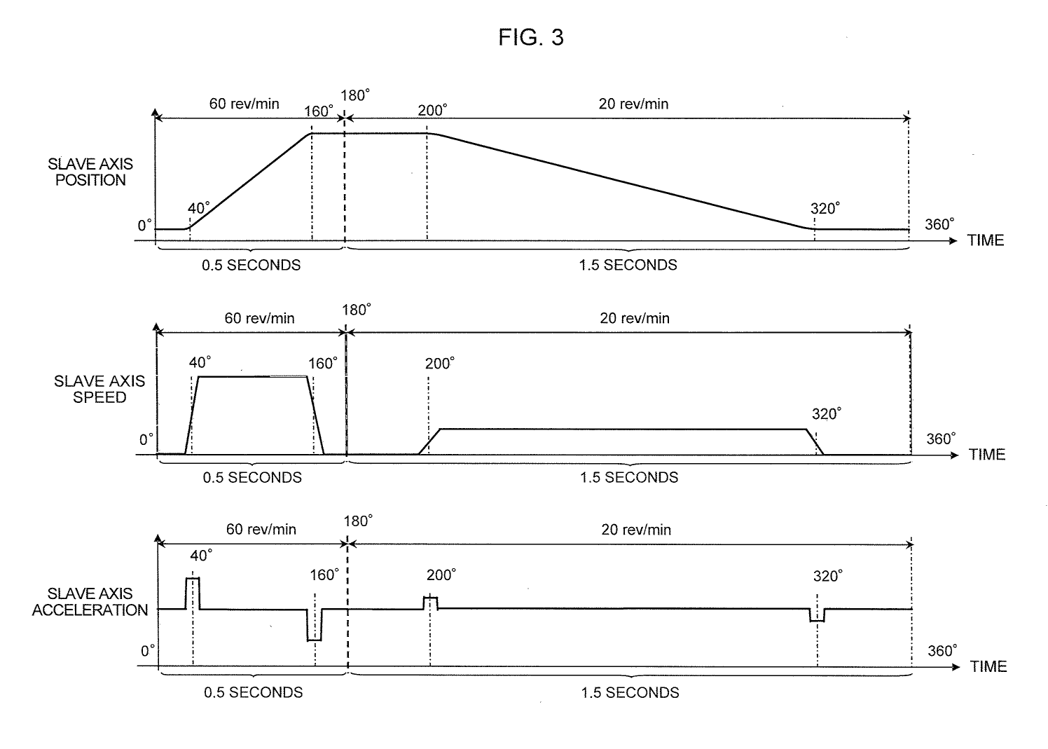

FIG. 3 shows an example of waveform display that can be generated by the waveform generation unit 105. The top graph of FIG. 3 shows waveform display in which the abscissa and the ordinate represent the time elapsed since the phase 0° and the position of the slave axis, respectively. According to this waveform display, the motion of the slave axis with the passage of time can be visually ascertained even when the rotational speed of the camshaft changes.

The middle graph of FIG. 3 shows waveform display in which the abscissa and the ordinate represent the time elapsed since the phase 0° and the speed of the slave axis, respectively. The slave axis speed can be calculated based on the execution time and the difference in the slave axis position between the phases. According to this waveform display, the speed pattern can be visually ascertained, and the maximum value of the operating speed of the slave axis and the location (time) of the maximum value can be identified. Moreover, it can be determined whether or not a specified speed is exceeded.

The bottom graph of FIG. 3 shows waveform display in which the abscissa and the ordinate represent the time elapsed since the phase 0° and the acceleration of the slave axis, respectively. The slave axis acceleration can be calculated based on the execution time and the difference in speed between the phases. According to this waveform display, the maximum value of the acceleration of the slave axis and the location (time) of the maximum value can be identified. Also, the maximum load of a motor can be calculated.

Moreover, a jerk, which is an amount of change of the acceleration, can be confirmed by displaying a waveform (not shown) in which the abscissa and the ordinate represent the elapsed time and the difference in the acceleration, respectively. In this way, the cam-shape data can be modified so as to adjust the jerk, and a smoother acceleration change can be obtained by adjusting the jerk.

Alternatively, the camshaft rotational speed acquisition unit 103 may be configured to acquire rotation direction information indicative of the direction of rotation of the camshaft, along with the rotational speed. Based on the rotation direction information, the waveform generation unit 105 can determine whether the camshaft is rotating forward (or the phase is changing from 0° to 359° or whether the camshaft is rotating reverse or reversed (or the phase is changing from 359° to 0°. If the camshaft rotates in the opposite direction to the normal direction or if a reciprocating motion is performed with the rotation direction reversed in the middle, the abscissa of the graph may be transformed from the conventional phase axis to the time axis and the time axis may be reversed so that a waveform containing the rotation direction information can also be generated.

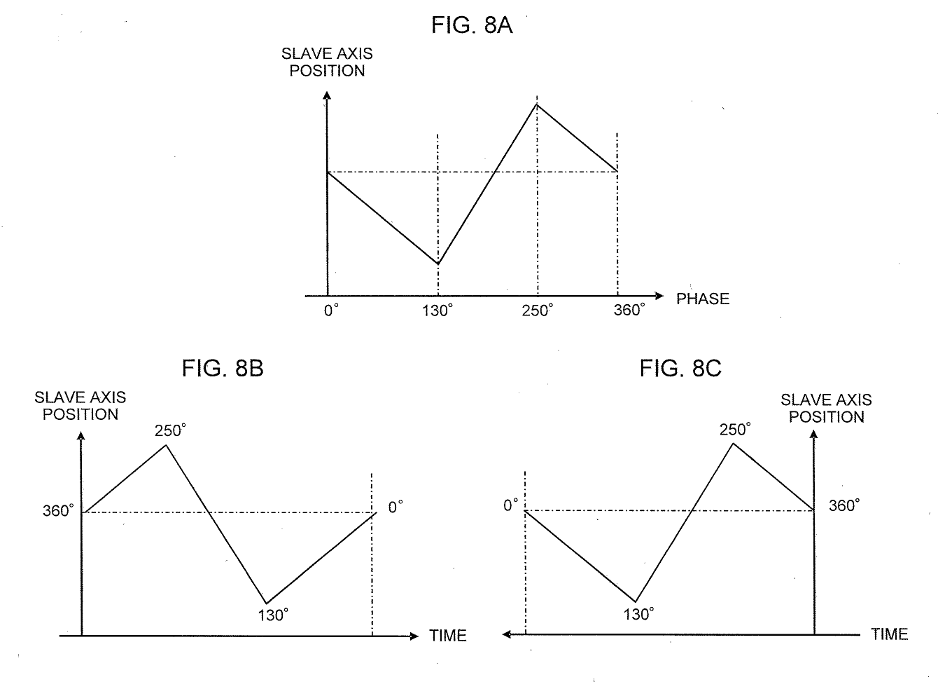

For example, the cam-shape data storage unit 101 is assumed to be stored with cam-shape data such as that shown in FIG. 8A. Such a waveform as shown in FIG. 8B is generated if a graph with the time axis as the abscissa is created according to the above-described embodiment in the case in which the rotation direction of the camshaft is reversed, that is, the phase changes from 359° to 0°. In comparing the shape with the cam-shape data, it is necessary only that the waveform generation unit 105 invert the abscissa of FIG. 8B and such a waveform as shown in FIG. 8C be generated. According to the waveform of FIG. 8C, the comparison with the cam-shape data of FIG. 8A is easy. Typically, the waveform generation unit 105 can perform switching between the waveform displays of FIGS. 8B and 8C in response to an instruction from a user.

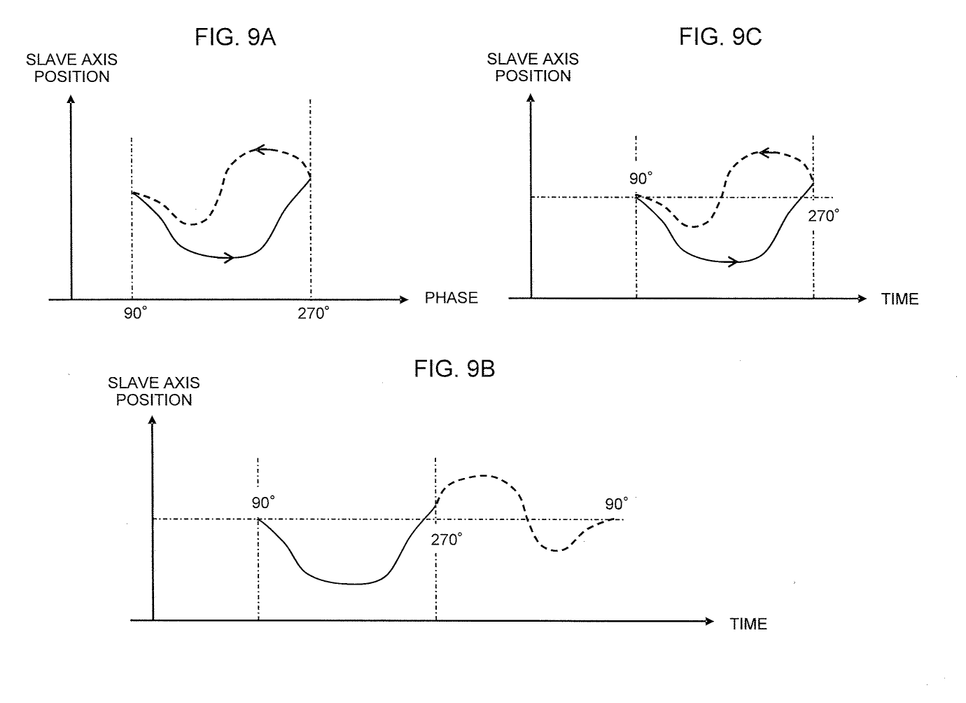

Moreover, for example, the cam-shape data storage unit 101 is assumed to be stored with cam-shape data such as that shown in FIG. 9A. This cam-shape data indicates that the camshaft starts to rotate at 90° and is reversed at 270° and restored again to 90°. In this case, such a waveform as shown in FIG. 9B is generated if a graph with the time axis as the abscissa is created according to the above-described embodiment. The user can easily determine the rotation direction and the location of the reversal by displaying the waveform of FIG. 9B in varied forms depending on the rotation direction information, e.g., by discriminating the waveform using different line types and colors. For shape comparison with the cam-shape data, the waveform generation unit 105 should invert the abscissa of FIG. 9B at the time of reversal of the rotation direction of the camshaft, thereby generating such a waveform as shown in FIG. 9C. According to the waveform of FIG. 9C, the motion of the camshaft can be instinctively ascertained and the comparison with the cam-shape data of FIG. 9A is easy. Typically, the waveform generation unit 105 can perform switching between the waveform displays of FIGS. 9B and 9C in response to an instruction from the user.

Alternatively, the camshaft rotational speed acquisition unit 103 may be configured to acquire a rotation start phase along with the rotational speed. In this case, the waveform generation unit 105 can generate a waveform with the origin of the time axis set as the rotation start phase. In this way, the motion starting at the rotation start point can be confirmed.

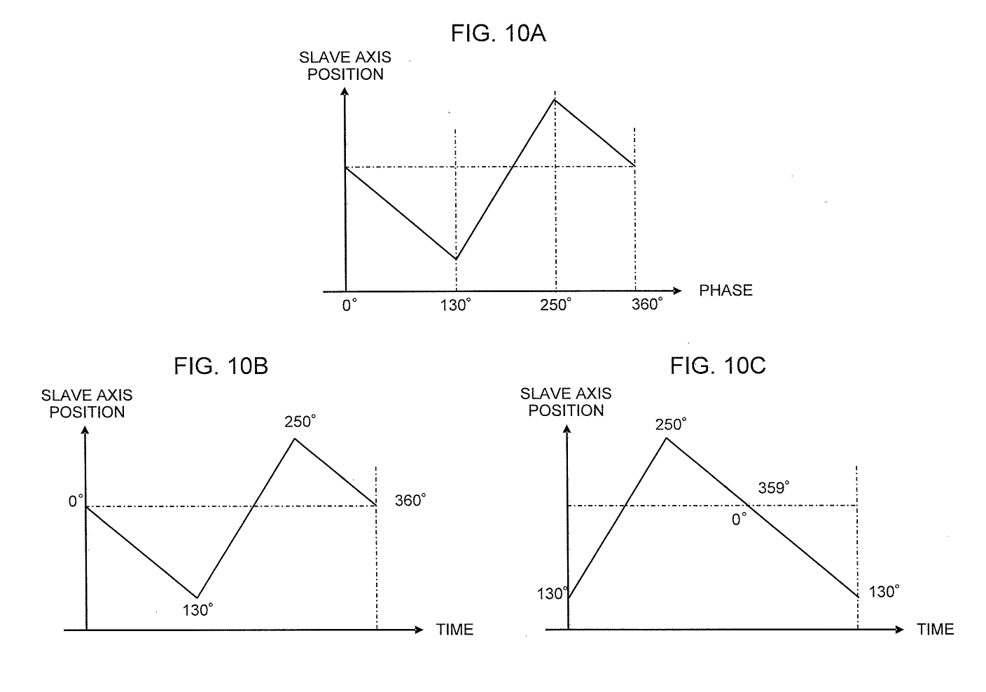

For example, the cam-shape data storage unit 101 is assumed to be stored with cam-shape data such as that shown in FIG. 10A. Such a waveform as shown in FIG. 10B is generated if a graph with the time axis as the abscissa is simply created according to the above-described embodiment. However, the camshaft does not always start to rotate at 0°. If the camshaft is assumed to have started rotating at 130°, for example, that part of the waveform of FIG. 10B on the left-hand side of 130° should be expected to be generated in the future. Actually, however, it is inevitably displayed as a past waveform. This contradiction occurs because the waveform is not generated in consideration of the zero time. In this case, therefore, the waveform generation unit 105 should generate such a waveform as shown in FIG. 10C starting at 130° for the rotation start phase. In this way, the waveform can be generated without involving any contradiction in the time axis.

Thus, according to the present embodiment, the waveform display of the cam-shape data based on the concept of time is generated using the waveform generation unit 105, the cam-shape data stored in the cam-shape data storage unit 101, and the rotational speed of the camshaft acquired by the camshaft rotational speed acquisition unit 103. In this way, the motion of the slave axis corresponding to the change of the rotational speed of the camshaft can be visually ascertained. Moreover, the maximum value of the speed or acceleration (and the maximum load of the motor) and the location (phase or time) of the maximum value can be identified, so that identification and modification of problem areas of the cam-shape data can be accurately performed. Moreover, the appropriateness of the speed and acceleration of the slave axis can be determined, so that the influences of the speed and acceleration can be predicted in advance even when the cam-shape data is modified.

The present invention is not limited to the embodiment described herein and may be suitably modified without departing from the spirit of the invention. Although the generation of the waveform display based on the time axis as the abscissa has been described in connection with the above embodiment, for example, the present invention is not limited to this and an alternative axis may be used as the time axis. Moreover, any other index that includes time as a factor may be used as the axis concerned in place of the simple time axis.

While an embodiment of the present invention has been described herein, the invention is not limited to the above-described embodiment and may be suitably modified and embodied in various forms.

1. A cam data display device which performs waveform display of a motion of an electronic cam, the cam data display device comprising:
a cam-shape data storage unit configured to store cam-shape data in which a phase of a camshaft is associated with a position of a slave axis;
a camshaft rotational speed acquisition unit configured to acquire a rotational speed of the camshaft; and
a waveform generation unit configured to generate the waveform display indicative of the relationship between time and the motion of the slave axis, based on the cam-shape data and the rotational speed of the camshaft.

2. The cam data display device according to claim 1, wherein the rotational speed of the camshaft changes in accordance with the phase.

3. The cam data display device according to claim 1, wherein the waveform generation unit generates the waveform display indicative of the relationship between time and the position of the slave axis.

4. The cam data display device according to claim 1, wherein the waveform generation unit generates the waveform display indicative of the relationship between time and a speed of the slave axis.

5. The cam data display device according to claim 1, wherein the waveform generation unit generates the waveform display indicative of the relationship between time and an acceleration of the slave axis.

6. The cam data display device according to claim 1, wherein the waveform generation unit generates the waveform display indicative of the relationship between time and a jerk of the slave axis.

7. The cam data display device according to claim 1, wherein the rotational speed acquisition unit acquires a measured value or a scheduled operating speed.

8. The cam data display device according to 1, claim wherein the rotational speed acquisition unit further acquires rotation direction information on the camshaft.

9. The cam data display device according to claim 8, wherein the waveform generation unit determines the rotation direction based on the rotation direction information and generates the waveform display with an axis indicative of the time inverted if the rotation direction is reversed.

10. The cam data display device according to claim 8, wherein the waveform generation unit determines the rotation direction based on the rotation direction information and generates the waveform display with an axis, indicative of the time after the point in time when the rotation direction is reversed, inverted if the rotation direction is reversed in the middle of rotation.

11. The cam data display device according to claim 8, wherein the waveform generation unit determines the rotation direction based on the rotation direction information and generates the waveform display in varied display forms depending on the rotation direction.

12. The cam data display device according to claim 1, wherein the rotational speed acquisition unit further acquires a rotation start phase of the camshaft, and the waveform generation unit generates the waveform display with the rotation start phase set to a zero time.
